(19) United States
(12) Patent Application Publication
(10) Pub. No.: US 2012/0236127 A1
(43) Pub. Date: Sep. 20, 2012

(54) Processor, Apparatus and Associated Methods

(75) Inventors: Pasi Ojala, Kirkkonummi (FI); Radu Ciprian Bilcu, Tampere (FI)

(73) Assignee: NOKIA CORPORATION, Espoo (FI)

(21) Appl. No.: 13/513,125

(22) PCT Filed: Dec. 4, 2009
(86) PCT No.: PCT/EP2009/008689

§ 371 Date: May 31, 2012

(51) Int. Cl. H04N 13/04; H04N 13/02

(52) U.S. Cl. 348/47; 348/51; 348/E13.075; 348/E13.053; 348/E13.074; 348/E13.014

(57) ABSTRACT

A processor configured to receive respective image data, representative of images, of the same subject scene from two or more image capture sources spaced apart at a particular predetermined distance; identify corresponding features from the respective image data; determine the change in position of the identified features represented in the respective image data; and identify the depth-order of the identified features according to their determined relative change in position to allow for depth-order display of the identified features according to their determined relative change in position.

### TECHNICAL FIELD

The present disclosure relates to the field of image processing, associated methods, computer programs and apparatus, and in particular concerns the representation of stereoscopic images on a conventional display. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Three-dimensional imaging, or stereoscopy, is any technique capable of creating the illusion of depth in an image. Typically, the illusion of depth is created by presenting a slightly different image to each of the observer's eyes, and there are various ways of achieving this. For example, to present a stereoscopic motion picture, two images are projected superimposed onto the same screen through orthogonal polarized filters. To appreciate the depth of the image, the observer may wear a pair of 3D glasses which contain a pair of orthogonal polarizing filters. As each filter passes only light which is similarly polarized and blocks the orthogonally polarized light, each eye sees one of the images, and the three-dimensional effect is achieved.

Autostereoscopy, on the other hand, is a method of displaying three-dimensional images that can be viewed without the need for polarized glasses. Several technologies exist for autostereoscopic 3D displays, many of which use a lenticular lens or a parallax barrier.

A lenticular lens comprises an array of semi-cylindrical lenses which focus light from different columns of pixels at different angles. When an array of these lenses are arranged on a display, images captured from different viewpoints can be made to become visible depending on the viewing angle. In this way, because each eye is viewing the lenticular lens from its own angle, the screen creates an illusion of depth.

A parallax barrier consists of a layer of material with a series of precision slits. When a high-resolution display is placed behind the barrier, light from an individual pixel in the display is visible from a narrow range of viewing angles. As a result, the pixel seen through each hole differs with changes in viewing angle, allowing each eye to see a different set of pixels, so creating a sense of depth through parallax.

Whilst the above-mentioned technology may be effective at creating the illusion of depth in an image, the requirement for polarized glasses or a specialised display is a disadvantage.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided a processor configured to:
receive respective image data, representative of images, of the same subject scene from at least two image capture sources spaced apart at a particular predetermined distance;
identify corresponding features from the respective image data;
determine the change in position of the identified features represented in the respective image data; and
identify the depth-order of the identified features according to their determined relative change in position to allow for depth-order display of the identified features according to their determined relative change in position.

The processor may be configured to depth-order the identified features for display such that the features which are determined to have changed position most are depth-ordered for display in front of features which are determined to have changed less in position.

Those identified features which are determined to have undergone a substantially similar change in position may be assigned to a layer lying parallel to a plane connecting the image capture sources, wherein the depth of the layer with respect to the plane connecting the image capture sources is unique. The term “substantially similar” in this case may refer to determined changes in position which are substantially the same, or which fall within some specified range.

Different points on the same feature which are determined to have undergone different changes in position may be assigned to different layers. Therefore, some features may be assigned to multiple layers.

The change in position may be determined with respect to a reference point. The reference point may be the centre of each image represented by the respective image data. The reference point could also be a corresponding edge of each image or a corresponding point located outside of each image.

The determined change in position may be the determined change in position of the centre of the identified features. Furthermore, the determined change in position may be a translational shift of the identified features, which might be a horizontal and/or vertical shift.

The number of identified features may be less than or equal to the total number of corresponding features present in the respective image data. The images may be represented by pixels, wherein each of the identified features comprises one or more groups of specific pixels. Each group of pixels may comprise one or more pixels.

The image data captured by the image capture sources may be captured substantially at the same time. Each image capture source may be one or more of a digital camera, an analogue camera and an image sensor for a digital camera. The image capture sources may be connected by a communication link to synchronise the capture and image processing. The image capture sources may reside in the same device/apparatus or different devices/apparatus.

The processor may be configured to calculate image data for a selected viewing angle based on the identified depth-order.

The processor may be configured to display calculated image data, the image data calculated based on the identified depth-order.

Advantageously, the processor may be configured to calculate image data for a selected viewing angle by interpolating one or more of the size, shape and translational shift position of the identified features. The processor may be configured to calculate image data for a selected viewing angle by extrapolating one or more of the size, shape and translational shift position of the identified features.

The image data from each image capture source may be encoded independently using an image compression algorithm. The calculated image data may be encoded using joint image coding. Advantageously, the calculated image data may be compressed by exploiting the redundancy between the image data from the image capture sources. One or more of the following may be encoded in the image data: the depth-order of the identified features, the depth-order of the layers, the relative difference in depth of the identified features, the relative difference in depth of the layers, and the layers to which the identified features have been assigned.

The shape of features which have been assigned to multiple layers may be smoothed in the calculated image. The shape of features in the calculated image may be interpolated or extrapolated using a morphing function.

According to a further aspect, there is provided a device/apparatus comprising any processor described herein. The device may comprise a display, wherein the display is configured to display an image corresponding to the selected viewing angle based on the calculated image data. The device may or may not comprise image capture sources for providing the respective image data to the processor.

The device may be one or more of a camera, a portable electronic/telecommunications device, a computer, a gaming device and a server. The portable electronic/telecommunications device, computer or gaming device may comprise a camera.

Advantageously, the processor may be configured to obtain the respective image data from a storage medium located locally on the device or from a storage medium located remote to the device. The storage medium may be a temporary storage medium, which could be a volatile random access memory. The storage medium may be a permanent storage medium, wherein the permanent storage medium could be one or more of a hard disk drive, a flash memory, and a non-volatile random access memory. The storage medium may be a removable storage medium such as a memory stick or a memory card (SD, mini SD or micro SD).

The processor may be configured to receive the respective image data from a source external to the device/apparatus, wherein the source might be one or more of a camera, a portable telecommunications device, a computer, a gaming device or a server. The external source may or may not comprise a display or image capture sources.

The processor may be configured to receive the respective image data from the external source using a wireless communication technology, wherein the external source is connected to the device/apparatus using said wireless communication technology, and wherein the wireless communication technology may comprise one or more of the following: radio frequency technology, infrared technology, microwave technology, Bluetooth™, a Wi-Fi network, a mobile telephone network and a satellite internet service.

The processor may be configured to receive the respective image data from the external source using a wired communication technology, wherein the external source is connected to the device/apparatus using said wired communication technology, and wherein the wired communication technology may comprise a data cable.

The viewing angle may be selected by rotating the display, adjusting the position of an observer with respect to the display, or adjusting a user interface element. The interface element may be a slider control displayed on the display.

The orientation of the display relative to the position of the observer may be determined using any of the following: a compass, an accelerometer sensor, and a camera. The camera may detect the relative motion using captured images. The camera may detect the observer's face and corresponding position relative to an axis normal to the plane of the display.

The processor may be a microprocessor, including an Application Specific Integrated Circuit (ASIC).

According to a further aspect, there is provided a method for processing image data, the method comprising:
receiving respective image data, representative of images, of the same subject scene from at least two image capture sources spaced apart at a particular predetermined distance;
identifying corresponding features from the respective image data;
determining the change in position of the identified features represented in the respective image data; and
identifying the depth-order of the identified features according to their determined relative change in position to allow for depth-order display of the identified features according to their determined relative change in position.

There is also provided a computer program recorded on a carrier, the computer program comprising computer code configured to operate a device, wherein the computer program comprises:
code for receiving respective image data, representative of images, of the same subject scene from at least two image capture sources spaced apart at a particular predetermined distance;
code for identifying corresponding features from the respective image data;
code for determining the change in position of the identified features represented in the respective image data; and
code for identifying the depth-order of the identified features according to their determined relative change in position to allow for depth-order display of the identified features according to their determined relative change in position.

The code could be distributed between the (two or more) cameras and a server. The cameras could handle the capturing and possibly also the compression of images while the server can do the feature and depth identification. Naturally, the cameras may have a communication link between each other to synchronise the capture and for joint image processing. When the camera modules reside in the same physical device, the above mentioned joint coding of two or more images would be easier.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

The above summary is intended to be merely exemplary and non-limiting.

### BRIEF DESCRIPTION OF THE FIGURES

A description is now given, by way of example only, with reference to the accompanying drawings, in which:

FIG. 1 illustrates schematically the capture of an image using two image capture sources spaced apart from one another;

FIG. 2 illustrates schematically the images captured by each of the image capture sources of FIG. 1;

FIG. 3 illustrates schematically the transitional shift in the horizontal and vertical axes of features identified in the images of FIG. 2;

FIG. 4 illustrates schematically the assignment of features identified in the images of FIG. 2 to specific layers;

FIG. 5 illustrates schematically a calculated image for a selected intermediate viewing angle;

FIG. 6a shows how the viewing angle can be selected by rotating the display;

FIG. 6b shows how the viewing angle can be selected by adjusting the position of the observer with respect to the display;

FIG. 7 illustrates schematically another pair of images captured by the image capture sources;

FIG. 8 illustrates schematically a calculated image for a selected intermediate viewing angle;

FIG. 9 illustrates schematically a processor for a device;

FIG. 10 illustrates schematically a device comprising a processor and image capture sources;

FIG. 11 illustrates schematically a device comprising a processor but no image capture sources;

FIG. 12 illustrates schematically a server comprising a processor and a storage medium;

FIG. 13 illustrates schematically a computer readable media providing a program; and

FIG. 14 illustrates schematically a flowchart for a method used to depth-order features in images.

### DESCRIPTION OF SPECIFIC ASPECTS/EMBODIMENTS

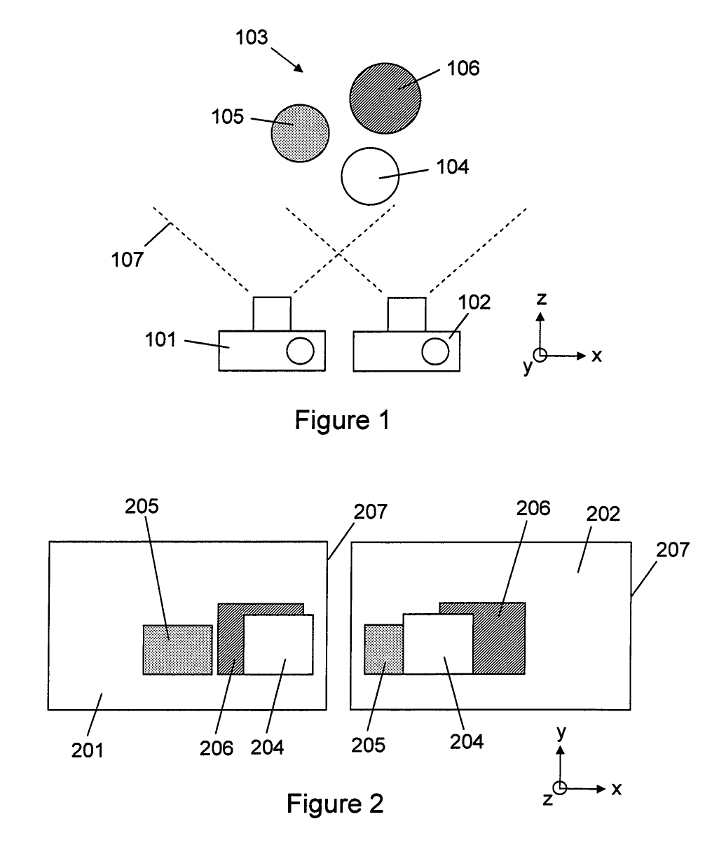

Referring to FIG. 1, there is illustrated schematically, in plan view, the capture of an image of a scene 103 using two image capture sources 101, 102 spaced apart from one another along the x-axis. The image captures sources may be two single lens cameras positioned side-by-side, or may comprise part of a multi-view camera. In this example, the scene comprises three cylindrical features 104, 105, 106 of different size arranged at different positions in three-dimensional space, the bases of the cylindrical features lying in the same plane (in this case, the xz-plane). The background image to the cylindrical features 104, 105, 106 is not shown.

The field of view of each image capture source is represented approximately by the dashed lines 107. As each image capture source captures an image of the scene from a different viewpoint, the features of the scene appear differently from the perspective of image capture source 101 than they do from the perspective of image capture source 102. As a result, the respective images 201, 202 (two-dimensional projections of the scene) captured by the image capture sources are different. The images captured by each of the image capture sources are illustrated schematically in FIG. 2. As can be seen, the position of the features 204, 205, 206 with respect to each other and with respect to the edges 207 of the image differs from one image 201 to the next 202. Although it is not clear from this schematic diagram, the relative size and shape of the features will also differ. Furthermore, any aspects of appearance present in the scene (be it shading, texture, reflection, refraction, transparency etc) may also differ between the respective images 201, 202 as a result of the differences in perspective.

When faced with a single two-dimensional image, an observer relies on the appearance of the features present in the image, and the overlap of these features, in order to perceive depth. For example, with respect to image 202 of FIG. 2, the fact that feature 204 overlaps features 205 and 206 indicates to the observer that feature 204 is closest to the image capture source 102. As there is no overlap between features 205 and 206, the observer would have to judge the relative depth of these features based on differences in shading, shadow, reflection of light etc. Even with the presence of these details, the relative depth of the features is not always obvious.

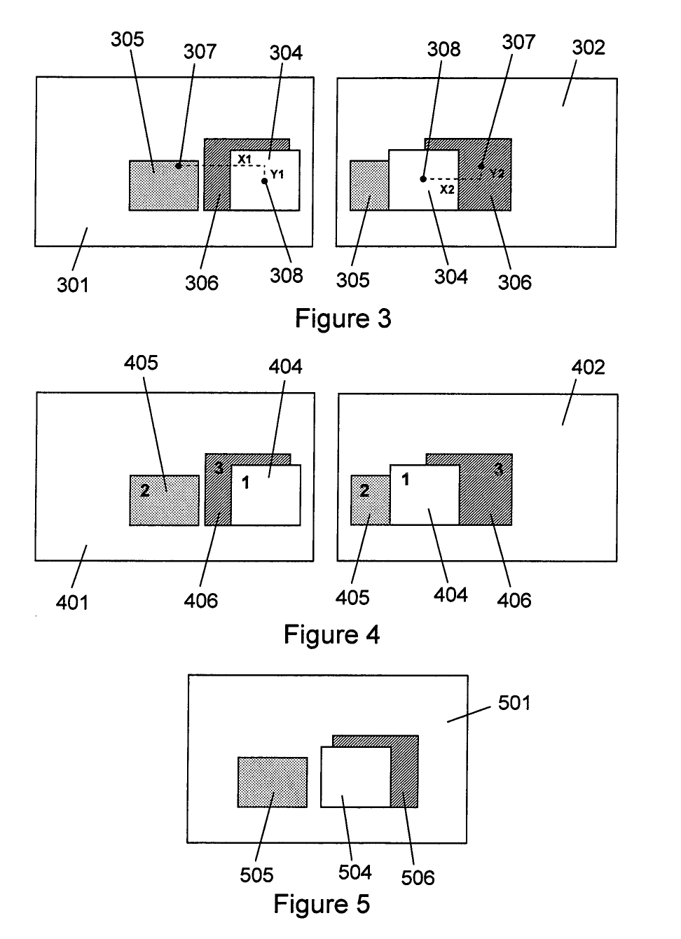

With reference to FIG. 3, there will now be described a method for determining the relative depth of the features 304, 305, 306 using multiple images 301, 302 of the same scene captured from different positions, without the need to rely on overlap or differences in shading, shadow, reflection etc between the features. This method is intended to be performed by a processor of a computer, but could theoretically be performed manually. Given that the manual approach would be particularly time-consuming for images with a large number of different features, however, the use of a processor would be more practical.

Starting with a pair of images 301, 302 captured according to FIG. 1, it is possible to determine the relative depth of the features 304, 305, 306 based on their changes in position from one image 301 to the next 302. The first step involves finding features in one image 301 which can be identified as the same features in the other image 302 (the correspondence problem). In practice the human eye could solve this problem relatively easily, even when the images contain a significant amount of noise. For a computer, however, this problem is not necessarily as straight forward and may require the use of a correspondence algorithm, which are known in the art (e.g. D Scharstein and R Szeliksi, A Taxonomy and Evaluation of Dense Two-Frame Stereo Correspondence Algorithms). In the present case, features 304, 305 and 306 are clearly corresponding features.

Having identified the corresponding features 304, 305, 306 from the respective images 301, 302 (or from the respective image data if the problem is being solved by a computer), the next step is to determine the change in position between images of each identified feature. This can be considered with respect to a reference point (e.g. a co-ordinate origin) which can be a point on the identified feature itself. The reference point can be any point inside or outside the image, provided the same point is used with respect to each image. In FIG. 3, the exact centre of each image 307 is used as the reference point (which for this particular image represents a reasonable point to use a reference), but the bottom left hand corner, top right hand corner, or another reference point of the image could have been used. In other situations, it may be more appropriate to use a reference point on the feature itself (see below).

Likewise, the change in position may be the change in position of any point in the identified feature, provided the same point is used with respect to each image. In FIG. 3, the change in position is the change in position of the centre 308 of the identified features. Furthermore, the change in position is the translational shift of the features in the xy-plane of the image. The translational shift may be a horizontal (x-axis) and/or vertical shift (y-axis) depending on how the image capture sources 101, 102 were aligned when capturing the images. For example, in the present case, the features have undergone a horizontal shift, but no vertical shift, because the image capture sources were positioned at the same height (position on the y-axis). Had the image capture sources been positioned at different heights (but at the same position on the x-axis), the features would have undergone a vertical shift but no horizontal shift. Similarly, had the image capture sources been positioned at different positions on both the x and y axes, the features would have undergone both horizontal and vertical shifts.

Rather than just using two image capture sources to determine both the horizontal and vertical shift of each identified feature, the vertical shift could be determined independently using an additional image capture source (not shown) positioned at a different point on the y-axis from image capture sources 101 and 102 (e.g. immediately above or in-between image capture sources 101, 102). With this arrangement, the images captured by image capture sources 101 and 102 could be used to determine the horizontal shift of each feature, whilst the image captured by the third image capture source could be used in combination with at least one of the other images, 201 or 202, to determine the vertical shift of each feature. The vertical and horizontal shift calculations should result in similar depth order information and thus calculation of both shifts could be used as a verification of the depth order calculated for a feature.

Considering un-shaded feature 304, the horizontal and vertical distances from the centre 307 of image 301 to the centre 308 of feature 304 are denoted X1 and Y1, respectively. Likewise, the horizontal and vertical distances from the centre 307 of image 302 to the centre 308 of feature 304 are denoted X2 and Y2, respectively. The horizontal and vertical shifts are therefore (X1-X2) and (Y1-Y2), respectively. As mentioned above, the vertical shift in the present case is zero. The change in position may be determined in this way for every corresponding feature.

In the above example, the centre of the image 307 has been used. It will be appreciated that, in other embodiments, the horizontal/vertical shifts (change in position) of the identified feature can be obtained directly by determining a motion vector which defines the shift in position of the feature from one image 301 to the other image 302. In such a case, the reference point could be considered to be the starting position of the identified feature (e.g. by comparison of the starting point of the centre of the identified feature in image 301 with the ending point of the centre of the identified feature in image 302). It will be appreciated that the magnitude of the motion vector will represent the change in the position of the feature.

It turns out that the shift in position is related to the depth of the features (position on the z-axis). In FIG. 3, the horizontal shift of feature 304 is greater than the horizontal shift of features 305 and 306. As a result, feature 304 can be said to lie closest to the image capture sources 101, 102 in terms of its position on the z-axis. Since the horizontal shift of feature 305 is greater than the horizontal shift of feature 306, feature 305 may be said to lie closer to the image capture sources 101, 102 than feature 306. Feature 306 is therefore distanced furthest from the image capture sources 101, 102 of the three identified features 304, 305, 306. Effectively, relative depth information from the image (or image data if calculated by computer) can be obtained by comparing the determined change in position of each of the corresponding features.

The relative depth information can then be used to calculate images of the scene from viewing perspectives not captured by the image capture sources 101, 102. This calculation is performed by interpolating or extrapolating image data from each of the captured images as will be discussed shortly. Once the relative depth information is obtained for each of the corresponding features, the features may be ordered for display according to depth. The features which are determined to have changed in position most are depth-ordered for display in front of features which are determined to have changed less in position.

To simplify the ordering (which is useful when the images contain a large number of corresponding features), the features may be assigned to different layers (planes), each layer lying parallel to the xy-plane. In the above case, features 304, 305 and 306 may be assigned to different layers, each layer having a different depth (z-component). Those identified features which are determined to have undergone a substantially similar change in position may be assigned to the same layer. The term “substantially similar” may refer to determined changes in position which are substantially the same, or which fall within some specified range. Therefore, any features whose relative depth falls within the specified range of depths may be assigned to the same layer. The choice of the particular specified range of depths will depend on the subject scene (e.g. images of features taken at close up will have different specified ranges to those of features taken at a distance).

Also, different points on the same feature which are determined to have undergone different changes in position, and which are therefore positioned at different relative depths (i.e. the feature itself has a depth), may be assigned to different layers. Essentially this means that some features may be assigned to multiple layers. FIG. 4 illustrates the assignment of the various features 404, 405, 406 to different layers, the layers ordered numerically with layer 1 at the front of the image.

Once the features have been assigned to different layers, the calculation of images (or image data) from different viewing perspectives can be performed. The purpose of calculating such images is to enable the representation of an image on a conventional display 601 in such a way as to create the illusion of depth, without necessarily requiring the need for polarized glasses or specialised display technology. The technique involves presenting an image of the captured scene on the display 601 which corresponds to the observer's selected viewing perspective, as though the image had been captured from this selected position. If the observer then changes position, the image displayed on the screen also changes so that it corresponds to the new viewing perspective. It should be noted, however, that this technique does not produce a “three-dimensional” image as such. As mentioned in the background section, three-dimensional images require the presentation of two superimposed images at the same time (one for each eye) in order to create the three-dimensional effect. In the present case, a single two-dimensional image is produced on the display which changes to suit the position of the observer with respect to the display. In this way, the observer can appreciate the depth of the image by adjusting his position with respect to the display.

In one embodiment, the depth information obtained from the determined change in position of the identified features is encoded with the image data for each of the captured images. Each of the captured images is encoded separately, although the depth information is common to each image. Any redundancy between the images may be used to improve the overall compression efficiency using joint image coding. Coding and decoding of the images may be performed using known techniques.

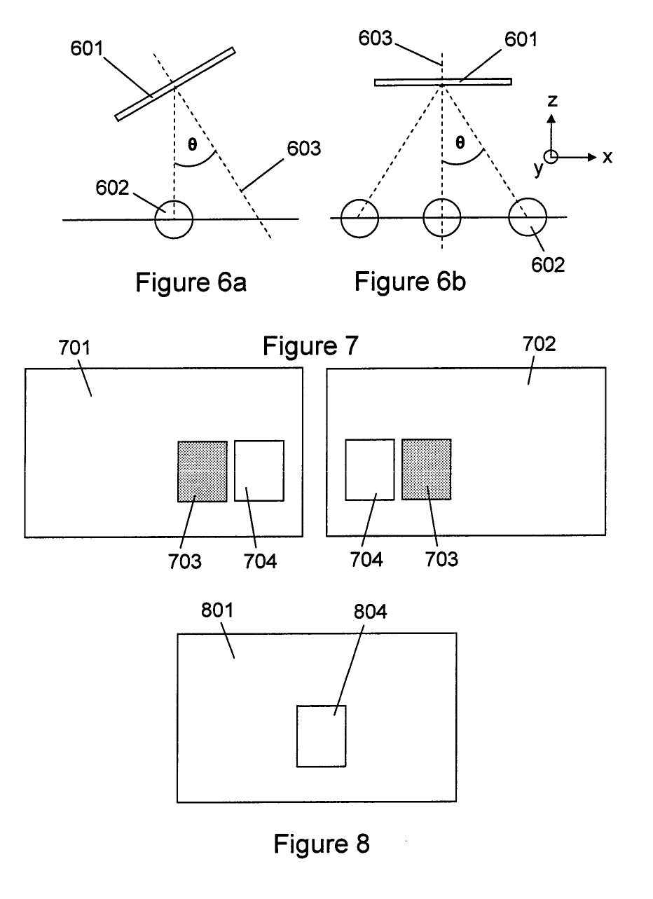

In order to calculate an image (or image data) for an arbitrary viewing perspective (which lies between the perspectives at which each image was captured), the size, shape and position of the identified features are interpolated from the features in the captured images (image data). Two scenarios can be considered, one where the display 601 is moved with respect to an observer 602 (e.g. in the case of a small hand-portable electronic device) as in FIG. 6a, and one where the observer 602 moves relative to the display 601 (e.g. in the case of a large TV/computer display which can not be readily moved) as in FIG. 6b.

As mentioned above, the perspective of the observer 602 may be selected by adjusting his position in the xy-plane with respect to the axis 603 normal to the centre of the plane of the display 601. The change in the observer position may be determined using appropriate sensing technology. In the present example, the image on the display would only vary if the observer changed position on the x-axis, as shown in FIG. 6b. This is because there was no vertical shift in the position of the image features. Had the image capture sources 101, 102 been positioned at different heights (i.e. different positions on the y-axis) during image capture, the image on the display would vary as the observer changed position on the y-axis. Likewise, had the features undergone both horizontal and vertical shifts, the image on the display would vary as the observer changed position on the x or y-axes, or both.

As mentioned above, the perspective of the observer may also be selected by adjusting the orientation of the display 601 with respect to the observer 602, keeping the position of the observer constant, as shown in FIG. 6a. The change in the display orientation may be detected using appropriate sensing technology. The orientation of the display may be adjusted by rotating the display about the x or y axes, or both. The angle, θ, defining the observer position from the axis 603 normal to the centre of the plane of the display 601 is indicated in FIGS. 6a and 6b.

To illustrate the calculation method, consider the scene in FIG. 1 as viewed from a position mid-way (on the x-axis) between the positions of the image capture sources 101, 102 at the same height (on the y-axis). This view may be selected by positioning the observer directly in front of the display. Knowing the size, shape and position (characteristics) of the features 404, 405, 406 in each image 401, 402, and the relative depth of the layers, the image (or image data) corresponding to this viewing perspective can be determined by averaging the values of these characteristics from the respective images (or image data). The calculated image 501 is shown in FIG. 5.

The average values of each characteristic can be weighted with respect to each of the captured images. For example, when the scene is viewed from the mid-way position as described above, the values of each characteristic will fall exactly between the values of those characteristics in the captured image data. As a result, the calculated image (shown on the display) will resemble image 1 just as much as it resembles image 2. On the other hand, if the observer's position is moved further to the left or right (on the x-axis) such that angle θ is increased, the calculated image corresponding to this new position will more closely resemble image 1 or 2, respectively. As angle θ increases, the calculated image (data) converges towards the nearest captured image (or image data) until eventually, at a pre-determined maximum value, the image displayed is identical to the captured image. In practise it does not matter exactly what the maximum value of θ is. For example, the display could be configured to display one of the captured images when angle θ is 30°. On the other hand, this captured image may not be displayed until θ is 45°. There may, however, be angular restrictions set by the practicality of observer position, and the degree to which a display can be rotated.

As well as calculating images corresponding to viewing perspectives between the perspectives of the image capture sources by interpolation (as mentioned above), the image data may be extrapolated to calculate images corresponding to viewing perspectives beyond the perspectives of the image capture sources based on extrapolating the interpolated data (or the captured image data). In this way, an increase in θ past the pre-determined “maximum value” (i.e. the value at which the image displayed is identical to one of the captured images) would produce an image corresponding to a broader perspective than that of image capture source 101 or 102, rather than simply converging to the captured image 201 or 202, respectively.

Furthermore, whilst the above description refers to the capture of images (sets of image data) from two image capture sources, there may be more than two image capture sources. For example, in FIG. 1 there could be a third image capture source (not shown) positioned on the x-axis to the left of image capture source 101, say. In this scenario, using image data generated from image capture source 101 and the additional image capture source, intermediate images could be calculated for perspectives between the positions of these image capture sources, in the same way as described above for image capture sources 101 and 102. The same calculated image could, however, be obtained by extrapolating the image data from image capture sources 101 and 102 as discussed in the previous paragraph. Also, as mentioned above, a third image capture source could be positioned above or below image capture sources 101 and 102 to determine the vertical shift information independently from the horizontal shift information.

As well as the size, shape and position of the features, other appearance characteristics may also be taken into account when calculating the image. For example the shading, texture, shadow, reflection, refraction or transparency of the features may be adjusted according to changes in orientation. The incorporation of these additional characteristics into the calculation may help to enhance the illusion of depth in the image.

The importance of the relative depth information should not be overlooked. To illustrate its importance, consider the captured images 701, 702 shown in FIG. 7. In this example there is no overlap between the features 703 and 704 in either image, so without obtaining the relative depth information, it is difficult to calculate an intermediate image because the order of the features is unknown. By determining the change in position of the corresponding features in the images, however, the order of the features becomes known and the intermediate image 801, as shown in FIG. 8, can be calculated. Feature 703 is located behind feature 704 in FIG. 8.

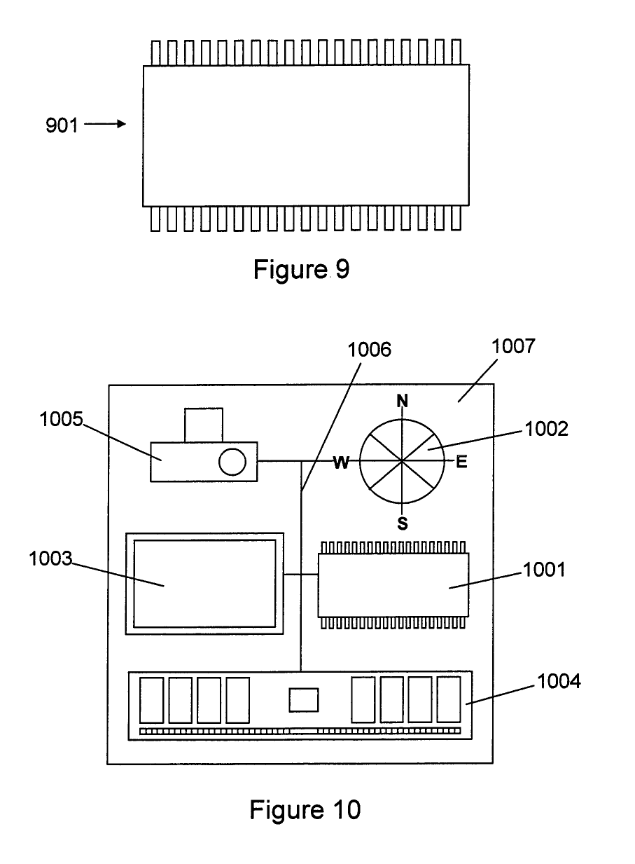

The apparatus required to perform the image processing described above will now be described. In FIG. 9 there is illustrated a processor 901 for a device. With reference to FIGS. 1 to 3, the processor is configured to receive respective image data representative of the images captured by the different image capture sources. The image data may be received directly from the respective image capture sources, may be received from a storage medium or may be received from a device located remote to the processor. The processor then solves the correspondence problem to identify corresponding features from the respective image data, and determines their change in position. Following this, the processor depth-orders the identified features for display according to their determined relative change in position. The features which have changed position most are depth-ordered in front on features which have changed less in position.

With reference to FIGS. 4 and 5, the processor is also configured to assign the features to layers based on their determined relative change in position, wherein the depth of each layer is unique. Using the relative depth information and image data received from the image capture sources, the processor calculates image data for a selected intermediate viewing angle by interpolating the size, shape and position of the identified features. The processor may be configured to calculate image data for a selected viewing angle by extrapolating the size, shape and position of the identified features. The processor 901 may be contained remote to the image capture sources used to capture the image data, so for example, the processor 901 may be located on a network server and be configured to receive the image capture from the remote image capture sources.

In FIG. 10 there is illustrated a device 1007 comprising a processor 1001, an orientation determinator 1002, a display 1003, a storage medium 1004 and two or more image capture sources 1005, which may be electrically connected to one another by a data bus 1006. The device 1007 may be a camera, a portable telecommunications device, a computer or a gaming device. The portable telecommunications device or computer may comprise a camera. The processor 1001 is as described with reference to FIG. 9.

The orientation determinator 1002 is used to determine the orientation of the display 1003 with respect to the position of the observer, and may comprise one or more of a compass, an accelerometer, and a camera. The orientation determinator may provide the orientation information to the processor 1001 so that the processor can calculate an image corresponding to this orientation.

The display 1003, which comprises a screen, is configured to display on the screen an image corresponding to the selected viewing angle, θ, based on the calculated image data. The display may comprise an orientation determinator 1002. For example, a camera located on the front of the display may determine the position of the observer with respect to the plane of the screen. The viewing angle may be selected by rotating the display, adjusting the position of the observer with respect to the display, or by adjusting a user interface element (e.g. display, physical or virtual slider/key/scroller). The user interface element may be a user operable (virtual) slider control (not shown) displayed on the display. The display may not contain a lenticular lens or a parallax barrier, and may only be capable of displaying a single two-dimensional image at any given moment.

The storage medium 1004 is used to store the image data from the image capture sources 1005, and could also be used to store the calculated image data. The storage medium may be a temporary storage medium, which could be a volatile random access memory. On the other hand, the storage medium may be a permanent storage medium, wherein the permanent storage medium could be one or more of a hard disk drive, a flash memory, and a non-volatile random access memory.

The image capture sources 1005 are spaced apart at a particular pre-determined distance, and are used to capture an image (or generate image data representing the image) of the same subject scene from their respective positions. Each image capture source may be one or more of a digital camera, an analogue camera and an image sensor for a digital camera. The images (image data) captured by the image capture sources may be captured substantially at the same time.

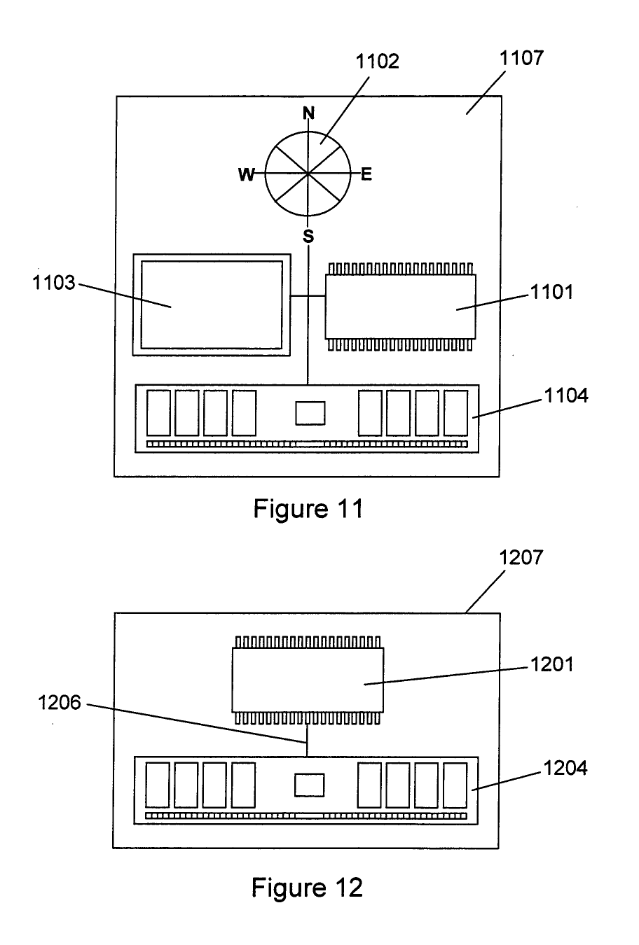

The device illustrated in FIG. 10 may be used to generate image data (using the image capture sources 1005), calculate images based on this image data (using the processor 1001), and display the calculated images on the display of the device (using the display 1003). In FIG. 11 there is illustrated a device 1107 as described with reference to FIG. 10, but which does not comprise the image capture sources 1005. In this scenario, the processor 1101 of the device would have to receive image data generated by image capture sources external to the device. The image data generated by the external image capture sources (not shown) could be stored on a removable storage medium and transferred to the device 1106. On the other hand, the image data generated by the external image capture sources may be transferred directly from the external image capture sources to the device 1106 using a data cable or wireless data connection (not shown). Once the captured image data is received by the processor 1101, the calculation of images (image data) based on this image data, the storage of the calculated images (calculated image data), and the display of the calculated images (calculated image data), may be performed using the processor 1101, storage medium 1104 and display 1103, respectively.

FIG. 12 illustrates schematically a server 1207 which may be used to receive image data generated by image capture sources external to the server. The server shown comprises a processor 1201 and a storage medium 1204, which may be electrically connected to one another by a data bus 1206. The image data generated by the external image capture sources (not shown) could be stored on a removable storage medium and transferred to the storage medium 1204 of the server 1207. On the other hand, the image data generated by the external image capture sources may be transferred directly from the external image capture sources to the storage medium 1204 of the server 1207 using a data cable or wireless data connection (not shown). Once the captured image data is received by the processor 1201, the calculation of images (image data) based on this image data and the storage of the calculated images (calculated image data) may be performed using the processor 1201 and storage medium 1204, respectively. The calculated image data may then be transferred from the server 1207 to a device external to the server 1207 for display.

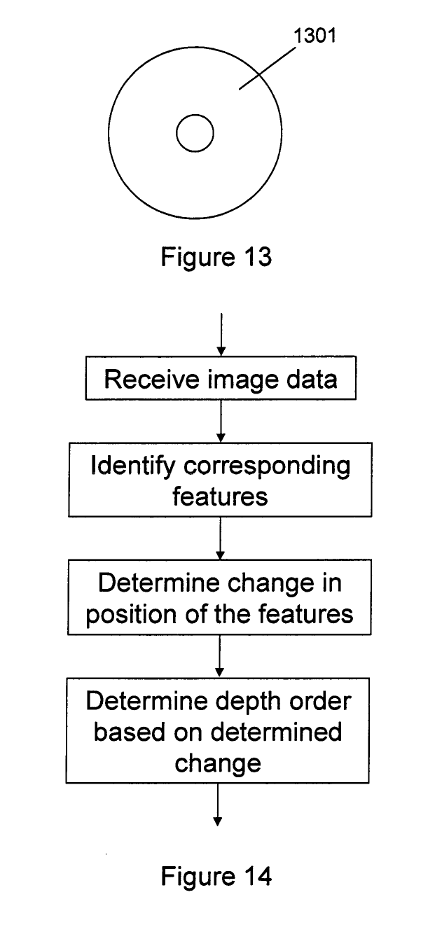

FIG. 13 illustrates schematically a computer/processor readable media 1301 providing a computer program according to one embodiment. In this example, the computer/processor readable media is a disc such as a digital versatile disc (DVD) or a compact disc (CD). In other embodiments, the computer readable media may be any media that has been programmed in such a way as to carry out an inventive function. The readable media may be a removable memory device such as a memory stick or memory card (SD, mini SD or micro SD).

The computer program may comprise code for receiving respective image data, representative of images, of the same subject scene from two or more image capture sources spaced apart at a particular predetermined distance, code for identifying corresponding features from the respective image data, code for determining the change in position of the identified features represented in the respective image data, and code for identifying the depth-order of the identified features according to their determined relative change in position to allow for depth-order display of the identified features according to their determined relative change in position. A corresponding method is shown in FIG. 14. It will be appreciated that in computer implementations of the method, appropriate signalling would be required to perform the receipt, identification and determination steps.

The computer program may also comprise code for assigning the features to layers based on their relative change in position, and code for calculating image data for a selected viewing angle using the relative depth information and received image data, wherein the image is calculated by interpolating or extrapolating the size, shape and position of the identified features.

Other embodiments depicted in the figures have been provided with reference numerals that correspond to similar features of earlier described embodiments. For example, feature number 1 may also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

At least three implementation scenarios have been described. In the first scenario, a single device (camera/phone/image sensor) captures the image data, calculates the interpolated/extrapolated image data, and displays the calculated image to the user. In the second scenario, a first device (camera/phone/image sensor) is used to capture the image data, but a second device (camera/phone/computer/gaming device) is used to calculate and display the interpolated/extrapolated image. In the third scenario, a first device (camera/phone/image sensor) is used to capture the image data, a second device (server) is used to calculate the interpolated/extrapolated image, and a third device is used to display the interpolated/extrapolated image (camera/phone/computer/gaming device).

It will be appreciated to the skilled reader that any mentioned apparatus/device/server and/or other features of particular mentioned apparatus/device/server may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus/device/server may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus/circuitry/elements/processor may have other functions in addition to the mentioned functions, and that these functions may be performed by the same apparatus/circuitry/elements/processor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-26. (canceled)

27. An apparatus, the apparatus comprising a processor, the processor configured to:
receive respective image data, representative of images, of the same subject scene from two or more image capture sources spaced apart at a particular predetermined distance;
identify corresponding features from the respective image data;
determine the change in position of the identified features represented in the respective image data; and
identify the depth-order of the identified features according to their determined relative change in position to allow for depth-order display of the identified features according to their determined relative change in position.

28. An apparatus according to claim 27, wherein the processor is configured to depth-order the identified features for display such that the features which are determined to have changed position most are depth-ordered for display in front of features which are determined to have changed less in position.

29. An apparatus according to claim 27, wherein the processor is configured to, for those identified features which are determined to have undergone a substantially similar change in position, assign to a layer lying parallel to a plane connecting the image capture sources, and wherein the depth of the layer with respect to the plane connecting the image capture sources is unique.

30. An apparatus according to claim 27, wherein the change in position is determined with respect to a reference point.

31. An apparatus according to claim 27, wherein the processor is configured to calculate image data for a selected viewing angle based on the identified depth-order.

32. An apparatus according to claim 27, wherein the apparatus comprises a display, and wherein the display is configured to display an image corresponding to a selected viewing angle using calculated image data based on the identified depth-order.

33. An apparatus according to claim 32, wherein the apparatus is configured such that the viewing angle is user selected by rotating the display, adjusting the position of an observer with respect to the display, or adjusting a user interface element.

34. An apparatus according to claim 27, wherein the apparatus comprises the two or more image capture sources, and wherein the processor is configured to receive the respective image data from the two or more image capture sources.

35. A method, the method comprising:
receiving respective image data, representative of images, of the same subject scene from two or more image capture sources spaced apart at a particular predetermined distance;
identifying corresponding features from the respective image data;
determining the change in position of the identified features represented in the respective image data; and
identifying the depth-order of the identified features according to their determined relative change in position to allow for depth-order display of the identified features according to their determined relative change in position.

36. A method according to claim 35, comprising depth-ordering the identified features for display such that the features which are determined to have changed position most are depth-ordered for display in front of features which are determined to have changed less in position.

37. A method according to claim 35, comprising assigning those identified features which are determined to have undergone a substantially similar change in position to a layer lying parallel to a plane connecting the image capture sources, wherein the depth of the layer with respect to the plane connecting the image capture sources is unique.

38. A method according to claim 35, comprising calculating image data for a selected viewing angle by interpolating the size, shape and position of the identified features.

39. A method according to claim 35, comprising displaying an image corresponding to a selected viewing angle using calculated image data based on the identified depth-order.

40. A method according to claim 39, comprising selecting the viewing angle by rotating the display, adjusting the position of an observer with respect to the display, or adjusting a user interface element.

41. A computer program recorded on a carrier, the computer program comprising computer code configured to operate a device, wherein the computer program comprises:
code for receiving respective image data, representative of images, of the same subject scene from two or more image capture sources spaced apart at a particular predetermined distance;
code for identifying corresponding features from the respective image data;
code for determining the change in position of the identified features represented in the respective image data; and
code for identifying the depth-order of the identified features according to their determined relative change in position to allow for depth-order display of the identified features according to their determined relative change in position.
